(19) United States
(12) Patent Application Publication
(10) Pub. No.: US 2006/0018343 A1
(43) Pub. Date: Jan. 26, 2006

(54) Method for transmitting data packets between nodes of a communication network

(76) Inventor: Miguel De Vega Rodrigo, Woluwe St. Lambert Brussels (BE)

Correspondence Address: SIEMENS CORPORATION;INTELLECTUAL PROPERTY DEPARTMENT, 170 WOOD AVENUE, SOUTH, ISELIN, NJ, 08830, US

(21) Appl. No.: 11/186,106

(22) Filed: Jul. 21, 2005

(30) Foreign Application Priority Data
Jul. 23, 2004 (EP) 04017532.5

(51) Int. Cl. H04J 3/16

(52) U.S. Cl. 370/471

(57) ABSTRACT

Data packets are aggregated to form a burst in an aggregation buffer of an ingress node. A header of the burst containing information about the burst length is sent to a destination node, and after an offset time the burst is sent to the destination node. The burst length is calculated and the header is sent to the destination node before the aggregation of the burst is completed.

The invention concerns a method according to the preamble of claim 1 and a node of a network.

In networks, like Optical Burst-Switched (OBS) networks or optical networks, packets, e.g. Internet Protocol (IP) packets, Asynchrony Transfer Mode (ATM) cells or protocol data units (PDUs), are aggregated to bursts, like electrical or optical bursts, in order to be transferred through the network. The conversion of packets into bursts takes place in a node, like an ingress or edge node, of the network according to a certain aggregation strategy.

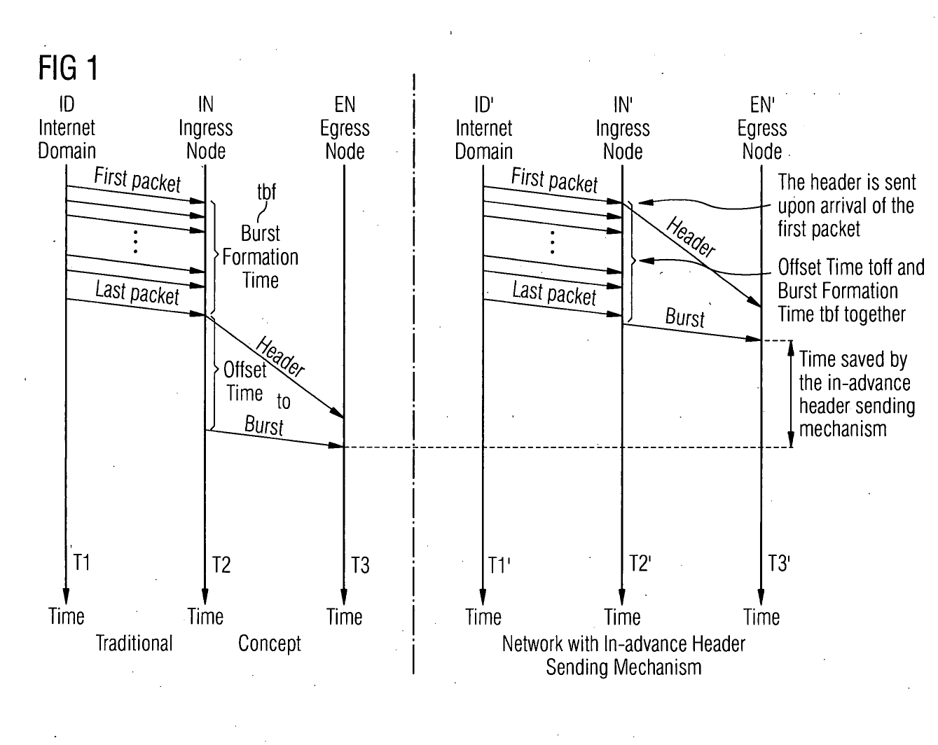

The process of sending a burst, like an optical burst, in a network, like an OBS network, is described as follows: First: Accumulate incoming packets, like IP packets, in an aggregation buffer of the node, until the burst is formed. Second: Send a header of the burst through the network containing information regarding the burst length. Third: Wait an offset time and send the burst. The offset time is necessary to prepare the switched paths in the nodes in order to transmit the burst from an ingress to an egress node. This offset time is network and node dependent. This process will be described in detail in conjunction with the embodiment by means of FIG. 1 left side.

According to this process, the delay experienced by a packet which is sent through a network can be therefore in the order of microseconds or even milliseconds, although the network might operate at speeds of Gbps. Consequently the delays derived from the use of burst switched networks can be unacceptable for many delay-sensitive applications.

It is therefore an object of the present invention to reduce the delay of a packet, which is transmitted via a burst switching network.

This object is achieved by a method with the features of claim 1 or a node with the features of claim 12.

The basic idea is to send the header of the burst to the network before the aggregation of the burst is completed. This has the advantage, that the delay of a packet transmitted via a burst and a burst switching network respectively is less than the delay of a packet transmitted via the traditional method.

Further developments of the invention are identified in subclaims.

In an embodiment of the invention the header of the burst is send immediately to the network when receiving a certain number of packets of a burst, instead of waiting until the burst is completed according to the traditional method. This has the advantage that according to the incoming average packet rate of the certain number of packets a burst length can be calculated and the delay of the packet is reduced, according to the invention.

In an embodiment of the invention the header of the burst is send immediately to the network when receiving the first packet of a burst. This has the advantage, that the lowest possible delay for a packet is achieved. (The offset time is started by sending the header. The burst is send after expiration of the offset time.)

In another embodiment of the invention, a new header is send immediately when the length of a burst exceeds the previously calculated length. This has the advantage, that the lowest possible delay is achieved for the following packets.

An exemplary embodiment of the invention is described in greater detail below with reference to a drawing.

Shown in the drawing are:

FIG. 1 schematic diagram of the traditional and in advance header sending mechanism.

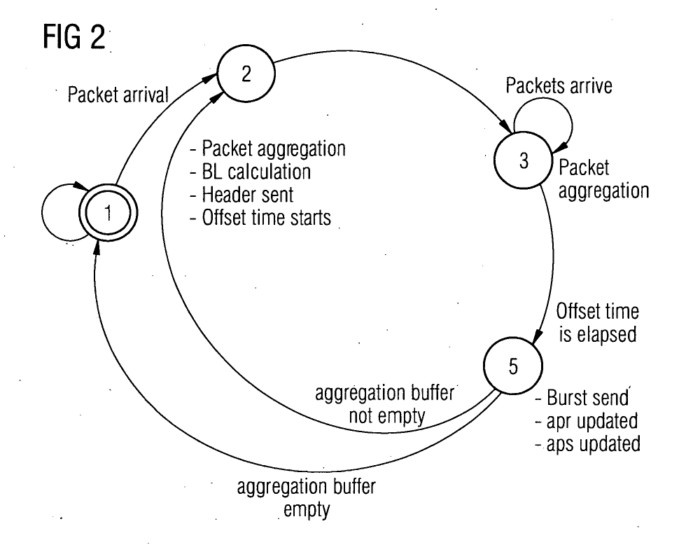

FIG. 2 a flowchart of a node using the inventive method.

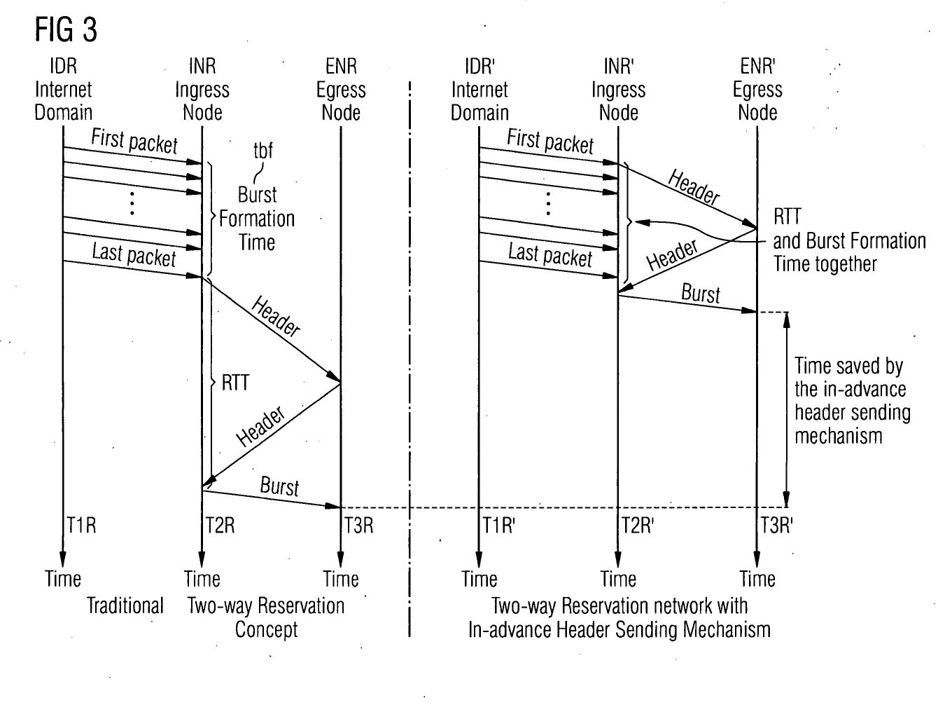

FIG. 3 schematic diagram of the traditional and in advance header sending mechanism in conjunction with the two-way reservation concept.

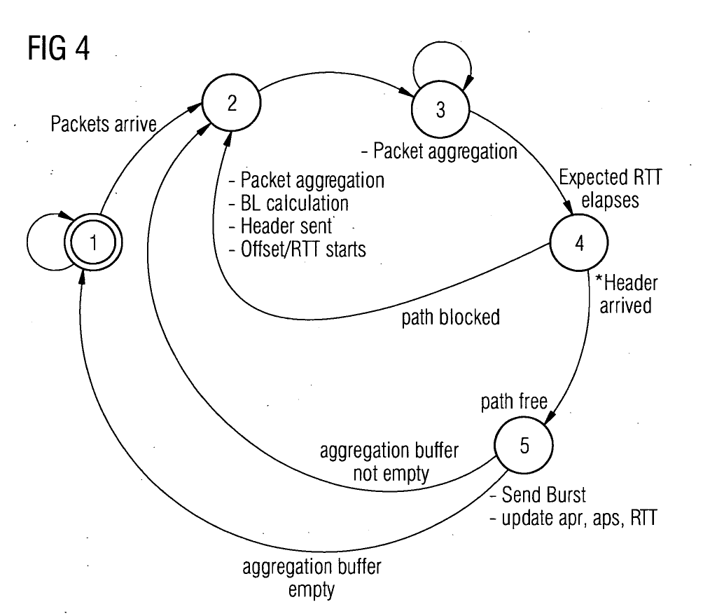

FIG. 4 a flowchart of a node using the inventive method in conjunction with the two-way reservation concept.

On the left side of FIG. 1 a schematic diagram of the traditional header sending mechanism method is shown with 3 time lines T1, T2, T3. Time line T1 is associated with an internet domain ID. Time line T2 is associated with an ingress node IN of a not shown optical burst switching network. Time line T3 is associated with an egress node EN of said optical burst switching network.

A number of packets, like IP packets, from the internet domain ID arrive at the ingress node IN. There said packets will be aggregated to a burst. The aggregation time is also called burst formation time tbf. After aggregation of the burst the burst length b1 or burst duration is determined and a header, like an optical header, is sent to the egress node EN containing the determined burst length b1 or burst duration. After or while sending the header an offset time toff starts in the ingress node IN and after expiration of the offset time to the (optical) burst is sent to the egress node EN.

The average delay experienced by a packet according to the described traditional method is:
Delay_{traditional}=burst formation time/2+offset time

On the right side of FIG. 1 a schematic diagram of the inventive in advance header sending mechanism method is shown with 3 time lines T1′, T2′, T3′. Time line T1′ is associated with the internet domain ID′. Time line T2′ is associated with an ingress node IN′ of a not shown optical burst switching network. Time line T3′ is associated with an egress node EN′ of said optical burst switching network.

A number of packets, like IP packets, from the internet domain ID′ arrive at the ingress node IN′. There said packets will be aggregated to a burst. After receiving a certain number of packets—e.g. the first packet, the third packet, the tenth packet, . . . —an estimation of the length or the duration of the burst is calculated and a (optical) header is sent to the egress node EN′ containing the calculated (estimated) burst length b1 or burst duration. While or after the sending of the header an offset time toff starts and after expiration of said offset time, which now defines the end of the burst formation time, the aggregation is stopped and from the ingress node IN′ the (optical) burst is sent to the egress node EN′. The burst formation time is at least partially overlapped by the offset time. The difference between the burst formation time tbf and the offset time toff is given by the time difference of the arriving of the first packet and the starting point of the offset time. In case the offset time starts by arriving of the first packet, the burst formation time tbf is equal to the offset time toff.

The average delay experienced by a packet according to the new inventive in advance header sending method is:
Delay_{new}=burst formation time/2=tbf/2

If the offset time starts with the arriving of the first packet, the average delay is:
Delay_{new}=offset time/2=toff/2

With the inventive method the delay is approximately less than half of the delay of a traditional burst switching network.

In the example of FIG. 1 the (optical) header travels slower than the (optical) burst due to the fact that in each (optical) node, e.g. switch, the (optical) header has to be processed (in the electrical domain), in order due to prepare the interconnection for the burst.

A detailed mechanism description is provided in FIG. 2 with a flowchart of a finite state automat that governs the functioning of an ingress respectively edge node.

The initial state of the automat is an idle state 1, where no action is performed. Upon arrival of a certain number of (IP) packets the automat moves to state 2, where the packets are aggregated, the burst length b1 or burst duration is estimated/calculated, the (optical) header is sent through the (OBS) network with an estimation of the burst length or duration and the offset time starts while or after sending the header. Packets will be aggregated at the ingress node—according to state 3—until the offset time is elapsed and the burst will be sent subsequently—state 4. The burst length or duration is calculated as the amount of packets or bits that are expected to arrive during this period. The bursts will not have always the same size as announced in the header, sometimes they will be bigger and sometimes smaller. If a burst has accumulated more packets or bits than expected during the offset time, only the announced burst length/amount of packets or bits in the header B_{announced} will be transferred, and the rest will remain in the aggregation buffer and a new header will be sent immediately which is shown as change from state 4 to state 2. In case the aggregation buffer is empty after sending the burst, there is a change from state 4 to state 1. In state 4 a measurement, calculation or estimation of the average packet rate apr or average packet size aps can be done. So the stored values for the average packet rate apr and average packet size aps used by the calculation of the burst length or duration can be updated according to behaviour/properties of the last incoming packet stream.

In order to estimate the amount of packets or bits arriving at the ingress or edge node during the offset time, two cases have to be identified:

Case 1: the aggregation buffer is empty or was emptied after sending the last burst. This means (see FIG. 2) that the header will be sent upon arrival of a certain number n of (IP) packets, and only after this moment the edge node will wait an offset time before sending the burst. This means that when this timer starts to count, there is already a certain number n of packets in the buffer. Therefore the estimated burst length is:

$$bl = [ n + apr \cdot toff ] \cdot aps \qquad Equation 1$$

where:
b1 burst length
n number of arrived packets
apr average packet arrival rate
toff offset time
aps average packet size, i.e. tri-modal distribution

In case, the header will be sent upon arrival of the first packets, the timer might start to count when there is the first packet in the buffer. The estimated burst length is:

$$bl = [ 1 + apr \cdot toff ] \cdot aps \qquad Equation 1 a$$

Case 2: the aggregation buffer was not emptied after sending the last burst and has a residual amount of B_{residual} bits. This means according to FIG. 2 (change from state 4 to state 2) that the header was immediately sent without waiting for a succeeding packet to arrive and the offset time starts again. The estimated burst length is:

$$bl = apr \cdot toff \cdot aps + {B}_{residual} \qquad Equation 2$$

Depending on weather the edge node is in case 1 or 2, a burst length given by equation 1 or equation 2 respectively will be announced in the header.

In other words, after the header is sent the edge node adds the incoming/succeeding packets to the burst which is being generated in the aggregation buffer, until the offset time toff elapses. Then the burst is sent and the packet arrival rate apr and average packet size aps is updated (state 4). The maximum size of the burst is equal to the burst length b1 announced in the optical header. Should the buffer contain less than this amount, the buffer will be emptied. Otherwise, the residual bits will be kept in the buffer, a segmentation of the last packet in the burst will probably take place, and a new optical header will be immediately generated and sent.

The edge node on the receiver side respectively egress node will reassembly the last packet of a burst if it was segmented, by simply recovering the second half of the packet at the beginning of the next burst that arrives from the same edge node.

The inventive method can be used in a two-way reservation network, like a two-way reservation optical burst switching network. In these networks the burst waits in the ingress node until the header travels to the destination edge node respectively egress node and comes back informing the ingress node of weather the burst will be blocked or not in the network. If no blocking will take place the burst is sent, since the header has already reserved the correspondent switching times in the switches along the path through the network. Otherwise, the burst is not sent, but instead another optical header is sent to the destination and the process is repeated.

The main advantage of this architecture is that it leads to blocking-free networks. However there is a design dilemma. Making the bursts small (and assuming a constant packet arrival rate), increases the amount of bursts in the network. Since for every burst a header has to be sent to the destination/egress node and back to the source/ingress node, the signalling overhead increases excessively. Making the bursts big would be in principle the right decision, since it leads to a higher multiplexing gain, but it also increases the burst formation time and consequently the packet delay, which can be simply unacceptable for many applications. The excessive delay makes it difficult to find a practical use for two-way reservation networks.

A solution is to use the inventive method with the in-advance header sending mechanism. The burst is formed while the header travels back and forth through the OBS network. The header round trip time RTT will be considerable, since the processing time in the switches takes a while. Therefore, bursts will have enough time to grow big in the edge nodes while the header returns from its trip. Consequently the solution provides the advantage that it allows to send big bursts (increased multiplexing gain) while reducing the packet delay drastically.

FIG. 3 explains intuitively the advantages of the in-advance header sending mechanism in two-way reservation (OBS) networks. On the left side of FIG. 3 a schematic diagram of the traditional header sending mechanism method in a two-way reservation network is shown with 3 time lines T1R, T2R, T3R. Time line T1R is associated with an internet domain IDR. Time line T2R is associated with an ingress node INR of a not shown optical burst switching network. Time line T3R is associated with an egress node ENR of said optical burst switching network.

A number of packets, like IP packets, from the internet domain IDR arrive at the ingress node INR. There said packets will be aggregated to a burst. The aggregation time is also called burst formation time tbf. After aggregation of the burst the burst length b1 or burst duration is determined and a header, like an optical header, is sent to the egress node ENR containing the determined burst length b1 or burst duration. The header reserves a path in the network while travelling to the egress node ENR. After arriving in the egress node ENR and successfully reservation of the path the header is sent back from the egress node ENR to the ingress node INR, in order to inform the ingress node INR that a path is successfully reserved. After arriving of the header in the ingress node INR the burst is sent to the egress node ENR. The travel time of the header from the ingress node INR to the egress node ENR and back is called round trip time RTT.

The average delay experienced by a packet according to the described traditional method of the two-way reservation concept is:

$$\begin{matrix}{DelayR}_{traditional} = burst formation time / 2 + round trip time \\ = tbf / 2 + RTT\end{matrix}$$

In case, the burst formation time is approximately equal to the round trip time, the average delay is:
DelayR_{traditional}=RTT/2+RTT=1.5*RTT

On the right side of FIG. 3 a schematic diagram of the inventive in advance header sending method used in conjunction with the two-way reservation concept is shown with 3 time lines T1R′, T2R′, T3R′. Time line T1R′ is associated with the internet domain IDR′. Time line T2R′ is associated with an ingress node INR′ of a not shown (optical) burst switching network. Time line T3R′ is associated with an egress node ENR′ of said burst switching network.

A number of packets from the internet domain IDR′ arrive at the ingress node INR′. There said packets will be aggregated to a burst. After receiving a certain number of packets n—e.g. the first packet, the third packet, the tenth packet, . . . —an estimation of the length or the duration of the burst is calculated and subsequently a header is sent to the egress node ENR′ containing the calculated (estimated) burst length b1 or burst duration. When or after the header is sent, a counter or timer is started, which uses the expected round trip time RTT analogue as the offset time toff as in the example of FIG. 1. The header reserves a path in the network while travelling to the egress node ENR′. After arriving in the egress node ENR′ and successful reservation of the path the header is sent back from the egress node ENR′ to the ingress node INR′, in order to inform the ingress node INR′ that a path is successfully reserved. After expiring of the expected round trip time RTT in the timer the aggregation is stopped. After arriving of the header in the ingress node INR′ the burst is sent to the egress node ENR′. The value of the round trip time of the header is measured continuously and an average value for the expected round trip time is updated and stored.

In order to calculate or estimate the burst length/amount of packets or bits in the burst, an analogue formula as described for FIG. 1 will be used. In this case the offset time is replaced by the round trip time.

$$bl = [ n + apr \cdot RTT ] \cdot aps \qquad Equation 3$$

where:
b1 burst length
n number of arrived packets
apr average packet arrival rate
RTT round trip time
aps average packet size, i.e. tri-modal distribution

In case, the header will be sent upon arrival of the first packets, the timer might start to count when there is the first packet in the buffer. The estimated burst length is:

$$bl = [ 1 + apr \cdot RTT ] \cdot aps \qquad Equation 3 a$$

Analogue to the description of FIGS. 1 and 2 in case the aggregation buffer was not emptied after sending the last burst and has a residual amount of B_{residual} bits, the burst length is calculated by:

$$bl = apr \cdot RTT \cdot aps + {B}_{residual} \qquad Equation 4$$

The average delay experienced by a packet according to the inventive method applied in a two-way reservation network is:
DelayR_{new mechanism}=Burst Formation Time/2

In case the header is sent after arriving of the first packet, the burst formation time is equal to the round trip time. The delay will be:
DelayR_{new mechanism}=RTT/2=0.5*RTT

As it can be seen, in two-way reservation networks a packet might experiences three times less delay if the inventive in-advance header sending mechanism is used.

FIG. 4 shows a flowchart of a node using the inventive method in conjunction with the two-way reservation concept. In FIG. 4 a flowchart analogue to FIG. 2 is shown. The difference is, that after the round trip time elapses the aggregation is stopped and a check is performed, if the header is arrived state 4. In case the header has arrived, the path is free and the burst will be send, which is shown as change from state 4 to state 5. In state 5 the burst is sent and the values for the average packet rate apr, average packet size aps and round trip time RTT are updated. If the header has not arrived, the path is blocked and a new header is sent, which is shown as change from state 4 to state 2. Consequently a new header will be sent in state 2.

If the aggregation buffer is empty after sending the burst there is a change from state 5 to state 1. In case the aggregation buffer is not empty there is a change from state 5 to state 2, where a new header will be sent—analogue to the description of FIG. 2.

In the following an example will be calculated. Suppose we have an OBS system that uses two-way reservation with the in-advance header sending mechanism. The system has to transport IP packets. Each edge node (ingress respectively egress node) is connected on the optical side to a 16*10 Gbps optical fiber (16 wavelengths). Assume that the header processing time in each optical node respectively switch is t_{processing}=10 μs (optic/electric/optic transformation+switching time), and that there are 10 optical nodes/switches between two given edge nodes. Therefore the time required for an optical header to travel from one edge node to the other and back—round trip time RTT—is approximately given by: RTT=10*10 μs (travelling 10 nodes to the destination)+10*10 μs (travelling 10 nodes to the source)=200 μs.

Let's calculate how many packets or bits are accumulated for a given edge node destination during these 200 μs. Assuming a realistic distribution of packet sizes, according to the tri-modal distribution the average IP packet size is aps=3735 bits

The average packet rate apr may be proportional to the speed of the link (160 Gbps). Assume that there are 16 possible destinations (edge nodes) and that the traffic is equally distributed among them. For a given destination, we have apr=10 [Gbps]/3735. [bits/packet]=2677.4*10³ packets/s. Therefore, in 200 μs a number of 2677.4*10³*200/10⁶=535.48 IP packets are sent in a burst, which is a recommendable number since it ensures a high multiplexing gain. In average, an IP packet has to wait 200 μs/2=100 μs in order to be transferred in a burst, if the header is sent by arriving of the first packet. Without the in-advance header sending mechanism, if we want to send bursts with 535 IP packets in average, an IP packet has to wait 200 μs/2 (until the burst is generated)+T_{RTT} (which is 200 μs)=300 μs, which is three times bigger as discussed.

Compendious a packet experiences a delay less than the half than in a normal burst switching network and three times less delay in a two-way reservation burst switching network. The performance for TCP connection over burst switching networks will be improved. The method does not demand much processing time and can be implemented in software. Using the burst aggregation strategy with timeouts, the offset time should be set equal to the value of the timer.

1-12. (canceled)

13. A method of transmitting data packets between nodes of a communication network, the packets aggregated to form a burst in an aggregation buffer included in an ingress node of the communication network, the method comprising:
aggregating the packets to form the burst;
calculating a burst length of the burst;
sending a header of the burst to a destination node of the communication network, the header including information about the burst length; and
sending the burst to the destination node after elapse of an offset time interval, wherein
the burst length is calculated before aggregation of the packets is completed, and
the header is sent to the destination burst before aggregation of the packets is completed.

14. The method as claimed in claim 13, wherein the burst length is calculated after receiving a number of but not all of the packets of the burst by the destination node, and the header is sent subsequently after said receiving.

15. The method as claimed in claim 14, wherein the burst length is calculated after the first of the number of packets is received by the destination node.

16. The method as claimed in claim 13, wherein, after aggregating a number of but not all of the packets of the burst, the burst length is calculated, the offset time interval starts, the header is sent to the destination node, and the burst is sent to the destination node after the elapse of the offset time interval.

17. The method as claimed in claim 13, wherein the burst length is calculated based on an average packet size, an average packet rate, and the offset time interval.

18. The method as claimed in claim 13, wherein the burst length is calculated from the mathematical product of an average packet size and a sum, the sum calculated from a number of currently aggregated packets plus the mathematical product of an average packet rate and the offset time interval.

19. The method as claimed in claim 13, further comprising determining a real burst length of the burst while aggregating the packets of the burst, wherein
aggregation of the packets of the burst is stopped,
odd packets and arriving packets are aggregated to a further burst, and
a header of the further burst is sent to the destination node, if the real burst length exceeds the calculated burst length while aggregating the packets of the burst.

20. The method as claimed in claim 19, wherein a burst length of the further burst is calculated by adding the number of the odd packets to the calculated burst length.

21. The method as claimed in claim 13, wherein an average packet rate is used for calculating the burst length, the average packet rate continuously calculated while aggregating the packets.

22. The method as claimed in claim 13, wherein the data packets are IP packets.

23. The method as claimed in claim 13, wherein the communication network is an Optical Burst Switching network.

24. A node of a communication network, comprising:
an aggregation buffer for storing a data burst formed by aggregating data packets; and
a control unit adapted to:
aggregate the data packets to form the data burst;
calculate a burst length of the data burst;
send a header of the data burst to a destination node of the communication network, the header including information about the burst length; and
send the burst to the destination node after elapse of an offset time interval, wherein
the burst length is calculated before aggregation of the packets is completed, and
the header is sent to the destination burst before aggregation of the packets is completed.
